(19) United States
(12) Patent Application Publication
(10) Pub. No.: US 2025/0065709 A1
(43) Pub. Date: Feb. 27, 2025

(54) Automotive Snorkel Incorporating an Air Filtration System

(71) Applicant: Work Air Technologies Pty Ltd, Wangara (AU)

(72) Inventor: Gregory Brian Knowles, Wangara (AU)

(21) Appl. No.: 18/719,196

(22) PCT Filed: Dec. 12, 2022
(86) PCT No.: PCT/AU2022/051493

§ 371 Date: Jun. 12, 2024

(30) Foreign Application Priority Data
Dec. 13, 2021 (AU) 2021904033

(51) Int. Cl. B60K 13/02; F02M 35/02; F02M 35/024; F02M 35/10

(52) U.S. Cl. CPC B60K 13/02; F02M 35/0212; F02M 35/024; F02M 35/1038

(57) ABSTRACT

An automotive snorkel is for a vehicle having an engine bay in which an engine incorporating an air intake system is located. The automotive snorkel includes a hollow housing having an upper opening and at least one lower outlet, a mounting box adapted to be received in the upper opening, and a plurality of removable filters. The mounting box includes a plurality of filter mounts and a filtration outlet to an external environment. Each filter is removable and adapted to be securely retained by a filter mount. Air only enters the snorkel by way of the upper opening where it is directed towards the filters that filter the particles entrained therein using centrifugal force. The separated particles thereafter are directed to the external environment by way of the filtration outlet. The filtered air is directed through the hollow housing to the lower outlets for subsequent delivery to the engine.

### FIELD OF THE INVENTION

The invention relates to an automotive snorkel incorporating an air filtration system. The invention is specifically directed for use with light vehicles, such as passenger vehicles, but is not limited to this particular use and has equal application to heavy vehicles such as haul trucks.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

An automotive snorkel finds use in situations where a vehicle engine itself may not be able to draw in sufficient air to continue operation. Due to the position of the engine relative to the vehicle, this may occur in high contaminant environments or where the vehicle is required to pass over flooded terrain.

In these situations, the automotive snorkel operates to draw air from a relative higher location about the vehicle and funnel that air towards the engine's air intake system(s). Commonly, air is drawn from an external point just below the roof of the vehicle cabin. An opening is made in the body of the vehicle through which the automotive snorkel extends to allow delivery of the air to the engine's air intake systems.

More importantly, the engine typically creates a suction force within the automotive snorkel. This significantly increases the possibility of blocking the vehicle engines standard pre-filters. Blocked pre-filters hinder the performance of the engine, if not prevent it from operating entirely.

It is therefore an object of the present invention to provide an alternative automotive snorkel that incorporates an air filtration system directed to resolving, at least in part, the aforementioned problem.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

In accordance with a first aspect of the present invention there is an automotive snorkel for a vehicle having an engine bay in which an engine incorporating an air intake system is located, the automotive snorkel comprising:
a hollow housing having an upper opening and at least one lower outlet;
a mounting box adapted to be received in the upper opening, the mounting box including a plurality of filter mounts and a filtration outlet to an external environment;
a plurality of removable filters, each removable filter being adapted to be securely retained by a filter mount,
   where air enters the snorkel by way of the upper opening and the filters uses centrifugal force to separate particles entrained therein and direct such particles to an external environment by way of the filtration outlet and where the purified air is directed through the hollow housing to at least one of the lower outlets for subsequent delivery to the air intake system.

The filtration outlet may open to a conduit in the hollow housing, the conduit leading to the external environment. Alternatively, flexible tubing may terminate at a connected end at the filtration outlet and either terminating at an unconnected end at a lower outlet separate to the lower outlet used to deliver purified air to the air intake system or the unconnected end extends through such lower outlet into the engine bay. This unconnected end of the flexible tubing may terminate in a nozzle.

The unconnected end, preferably, attaches to a vacuum source. The vacuum source may be a radiator fan of the vehicle.

The automotive snorkel may incorporate a face plate having a plurality of apertures provided therein, the face plate adapted to be received within the upper opening, such that air only enters the snorkel through the apertures. Preferably, each aperture in the face plate is coaxial with a filter mount, and each removable filter has a positioning lip, the face plate operable to sit on the positioning lip so as to properly position an end of the removable filter proximate the positioning lip in the apertures of the face plate.

Ideally, each filter mount comprises a hollow mount base and a hollow projection, the removable filter forming an interference fit with the hollow mount base when properly installed.

The filter mount may include a keying projection and the removable filter includes a notch, the notch adapted to receive the keying projection when the removable filter is properly installed about the hollow mount base. The keying projection of each filter mount may extend from the hollow mount base at the same position and at the same angle.

The removable filter may incorporate an inlet end and an outlet end, the inlet end divided into at least two segments, each segment incorporating a curved downwardly sloping wall that directs air that passing through the filter to form a vortex in the space between the hollow projection and an internal wall of the removable filter. Ideally, each downwardly sloping wall has an exterior end and an internal end, the internal end terminating at a position below the exterior end of an adjacent downwardly sloping wall.

The internal wall of each removable filter may be slightly tapered. As a variation, the removable filter may further include a middle segment. In such a configuration, the inlet end has a lateral cross-section of a first constant diameter and the outlet end has a lateral cross-section of a second constant diameter resulting in the middle segment slightly tapering as it moves from the outlet end to the inlet end.

the outlet end may incorporate a cut-out, where the separated particles are expelled into the mounting box by way of the cut-out.

Each removable filter may have at least an open state and a closed state and an active filtration system is operable to control the current state of each removable filter. The active filtration system may operate to control the current state of each removable filter based on measurements provided by at least one sensor. This sensor may be any of the following (or a combination thereof): a sensor to detect the current RPM of the engine; a sensor for detecting the current air pressure within the automotive snorkel. The change of stat for each removable filter may be achieved by way of any of the following: a butterfly valve; a guillotine valve.

In a further variation, the automotive snorkel also includes a reference dataset, the active filtration system operable to check the reference dataset against the measurements provided by the at least one sensor to determine an optimal number of open valves, the active filtration system operable to control the current state of each removable filter until the number of filters set to an open state is equal to the optimal number.

Alternatively, the filters may be manually set to a desired state.

The filter mounts may be arranged in columns within the mounting box, each filter mount in a column being in an offset position relative to the filter mounts in its adjacent columns.

The external environment may incorporate particulate storage means and particulates expelled to the external environment are directed for storage to the particulate storage means.

The opening may have an elongate rectangular shape. Preferably, the opening faces towards a windscreen of the vehicle.

Preferably, each of the at least one outlets opens out to the engine bay.

### BRIEF DESCRIPTION OF THE DRAWINGS

The invention will now be described, by way of example only, with reference to the accompanying drawings, in which:

FIG. 1 is a perspective view of an automotive snorkel according to a first embodiment of the invention.

FIG. 2 is an exploded view of the automotive snorkel as shown in FIG. 1.

FIG. 3 is a perspective view of an automotive snorkel as shown in FIG. 1 as installed on a light vehicle.

FIG. 4 is a top view of a mounting box as used in an automotive snorkel as shown in FIG. 1.

FIG. 5a is a perspective view of a removable filter as used in an automotive snorkel as shown in FIG. 1.

FIG. 5b is a cross-sectional view of the removable filter as shown in FIG. 5a.

FIG. 6 is an exploded view of an automotive snorkel according to a second embodiment of the invention.

FIG. 7a is a perspective view of a removable filter as used in an automotive snorkel as shown in FIG. 6.

FIG. 7b is a cross-sectional view of the removable filter as shown in FIG. 7b.

FIG. 8 is cross-sectional view of an automotive snorkel according to a third embodiment of the invention.

FIG. 9 is a schematic representation of an automotive snorkel according to a fourth embodiment of the invention.

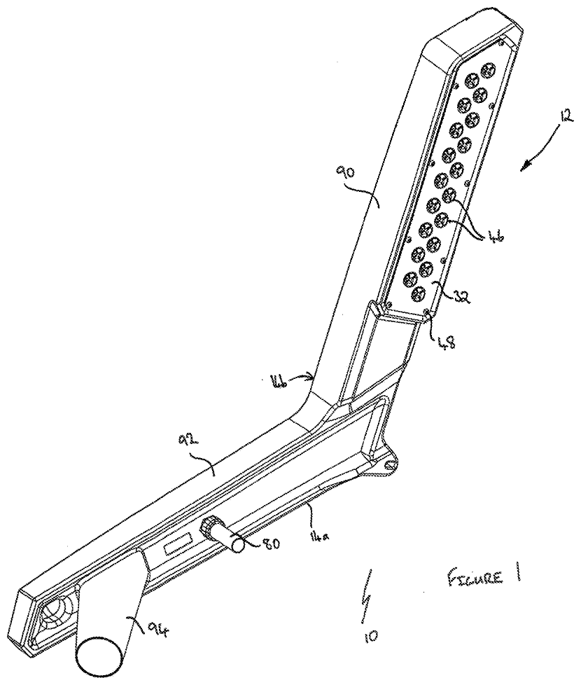

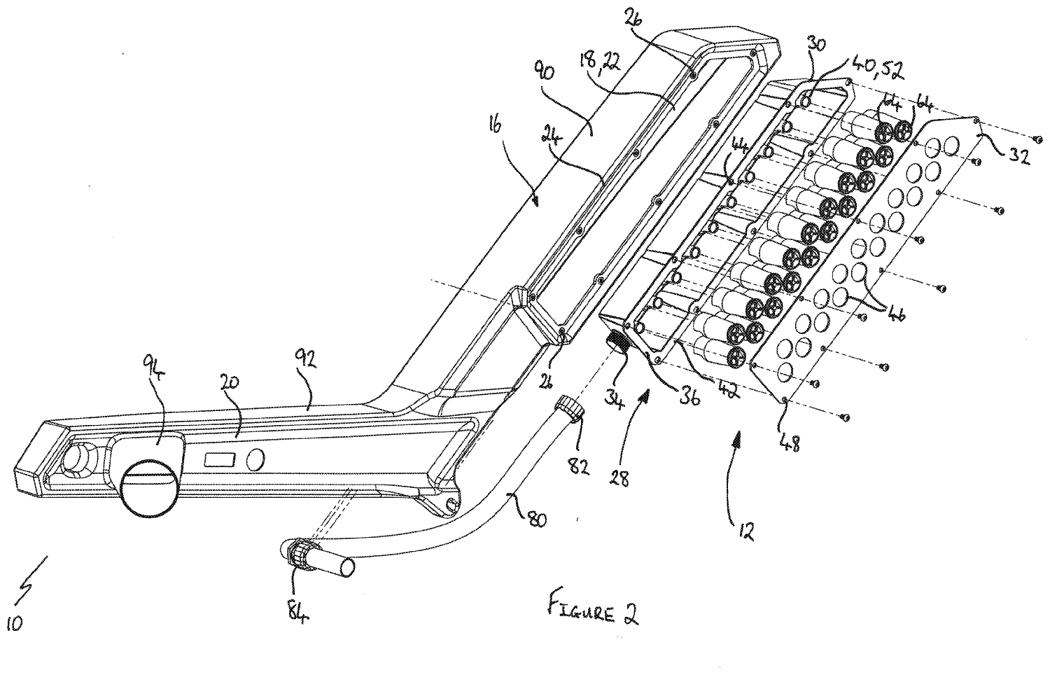

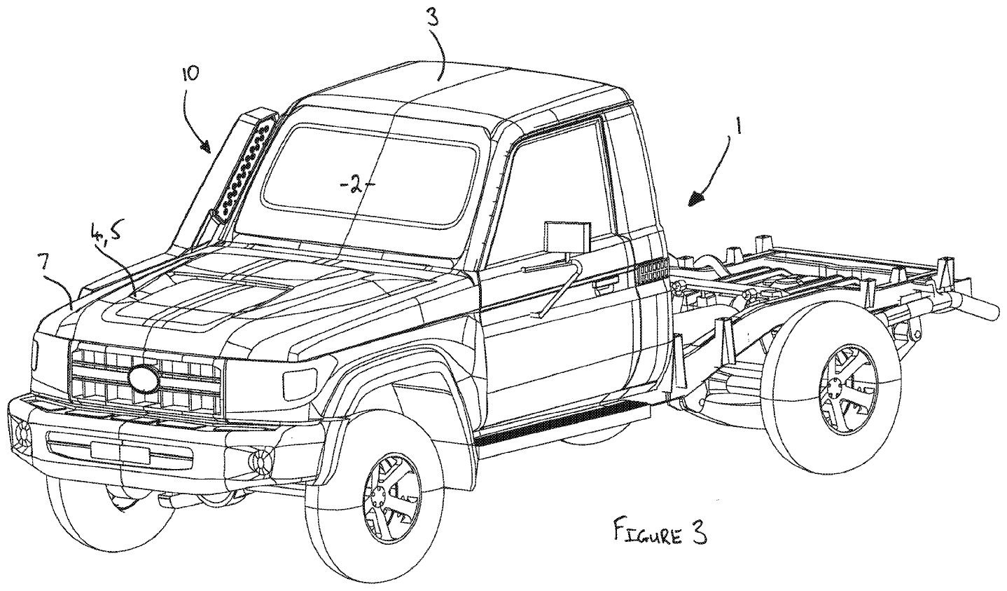

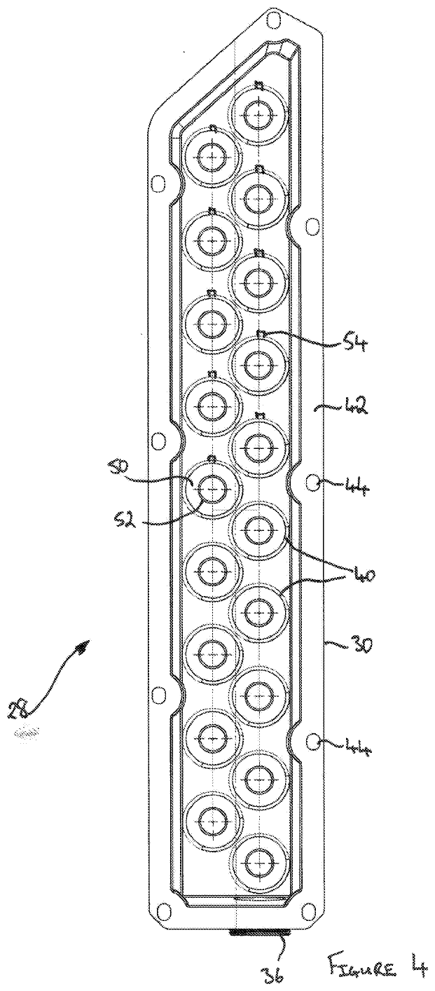

### PREFERRED EMBODIMENTS OF THE INVENTION

In accordance with a first embodiment of the invention there is an automotive snorkel 10 incorporating an air filtration system 12. The automotive snorkel 10 is fitted to a light vehicle 1.

The vehicle 1 has a windscreen 2, a roof 3 and a hood 4. The hood 4 is hinged to allow access to the vehicle's engine bay 5 where the engine 6 is housed. Front fenders 7 are located either side of the hood 4.

The automotive snorkel 10 comprises a first moulded half 14a and a second moulded half 14b. The first moulded half 14a and second moulded half 14b are welded together to form a hollow housing 16. The hollow housing 16 has an external open end 18 and a lower open end 20.

The opening 22 formed in the external open end 18 has an elongate rectangular shape. The opening 22 is side facing when the automotive snorkel 10 is properly installed.

Located about periphery 24 of the opening 22 are a plurality of threaded apertures 26.

A filter insert 28 is installed in the opening 22 but does not make contact with the automotive snorkel 10 other than as described below. The filter insert 28 comprises a mounting box 30 and a face plate 32. The mounting box 30 has a threaded outlet 34 provided in a lower end 36. Base 38 of mounting box 30 has a plurality of filter mounts 40 extending therefrom. The filter mounts 40 will be described in more detail below.

A flange 42 surrounds the mounting box 30. The flange 42 has a plurality of apertures 44 provided therein. The position of the apertures 44 about the flange 42 corresponds with the position of the threaded apertures 26.

The face plate 32 has a plurality of filter apertures 46 provided therein. The number of filter apertures 46 provided in the face plate 32 is equal to the number of filter mounts 40 extending from the base. Furthermore, each filter aperture 46 is in axial alignment with a filter mount 40.

Periphery of face plate 32 also has a plurality of securing apertures 48 provided therein. The position of the securing apertures 48 about the periphery of face plate 32 also corresponds with the position of the apertures 44 about the flange and the position of the threaded apertures 26. In this manner, a threaded bolt may pass through securing apertures 48, apertures 44 to threadedly engage threaded apertures 26.

As mentioned above, the base 38 has a plurality of filter mounts 40 extending therefrom. In this embodiment, the filter mounts 40 are arranged into two columns. The filter mounts 40 forming the first column hold an offset position relative to the filter mounts 40 in the second column.

Each filter mount 40 comprises a hollow mount base 50 and a hollow projection 52. The projection 52 and the mount base 50 have a circular lateral cross-section. The projection 52 extends centrally from the mount base 50. In this manner, the projection 52 and the mount base are concentrically aligned.

Each mount base 50 has a keying protrusion 54 extending therefrom. The keying protrusions 50 each extend from the mount base 50 at the same angle.

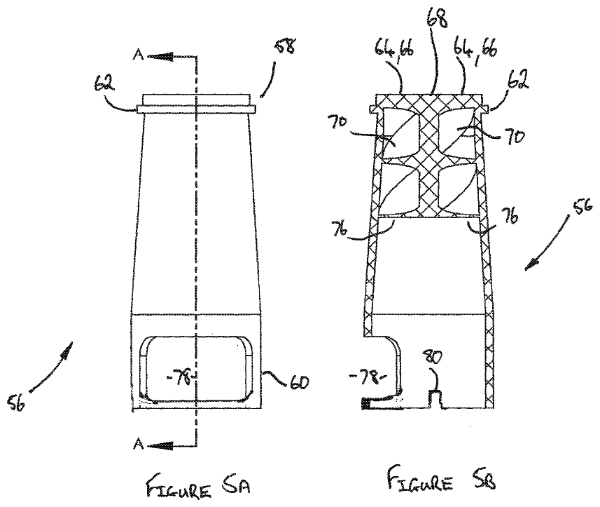

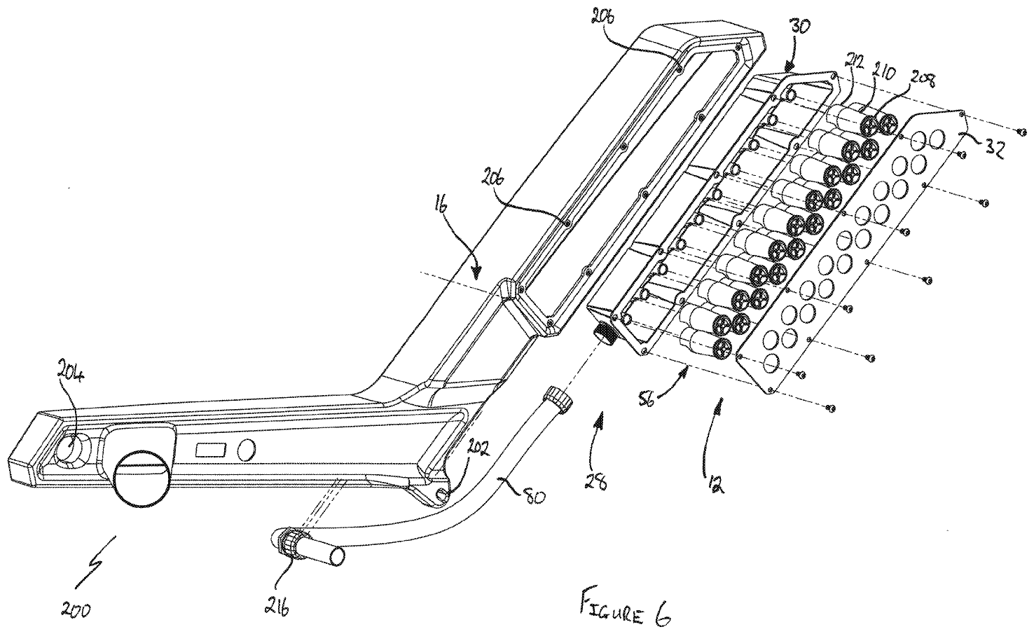

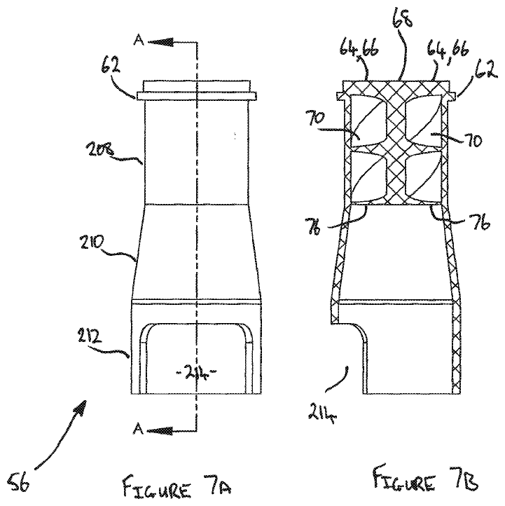

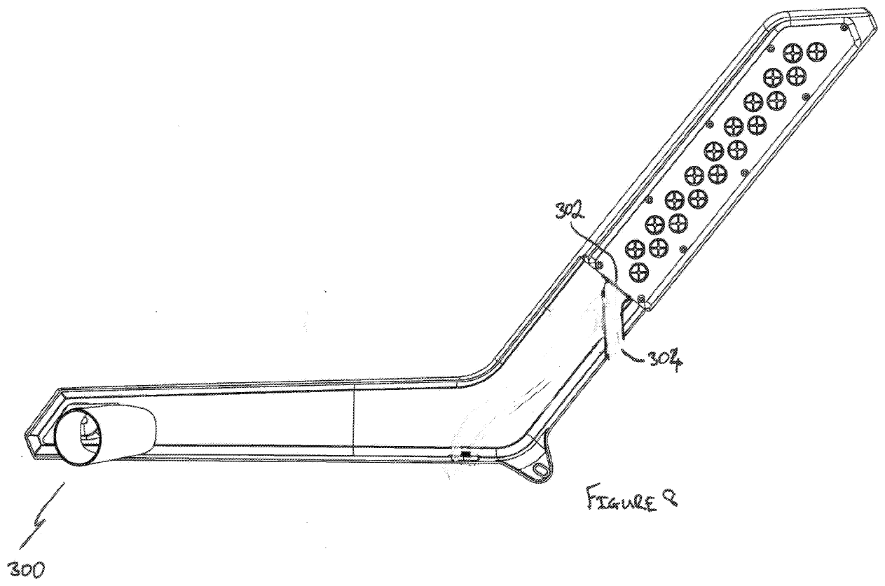

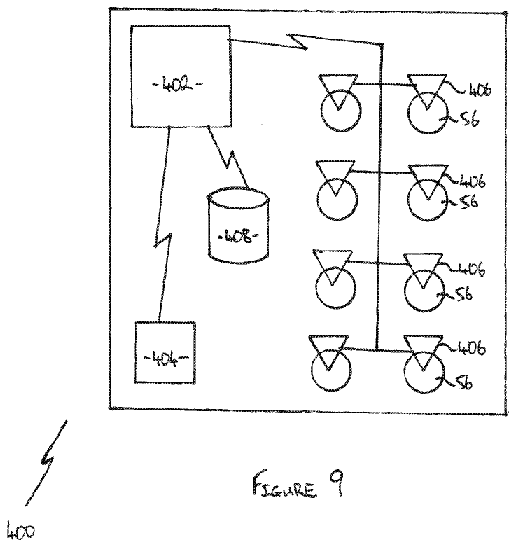

Each filter mount 40 is designed to facilitate the retention of a removable filter 56. The removable filter 56 is shown in FIGS. 5a and 5b.

The filter 56 has a face plate end 58 and a base end 60. The filter 56 has a slight inward taper as it extends from the base end 60 towards the face plate end 58. As such, both the face plate end 58 and the base end 60 are coaxial aligned about axis A-A, but base end 60 is of larger diameter than face plate end 58.

A positioning lip 62 extend about the circumference of the filter 56 at a position just short of the face plate end 58. In this embodiment, the distance between the positioning lip 62 and the face plate end 58 is equal to the thickness of the face plate 32.

The face plate end 58 of this embodiment is divided into four quadrants 64. Each quadrant 64 is separated from its adjacent quadrants 64 by crossbeams 66 that extends to a circular hub 68.

The crossbeams 66 and the circular hub 68 extends back towards the base end 60 to a point in general alignment with the lip 62.

Each quadrant 64 incorporates a curved downwardly sloping wall 70 provided therein. The wall 70 extends the full length of clockwise crossbeam 72 and the portion of the circular hub 68 that faces the quadrant 64. The wall 70 extends only partially along anti-clockwise crossbeam 74. In this manner, the wall 70 slopes downwards in an anti-clockwise direction until it reaches air inlet 76 creating something that is similar to a fan of static position.

An elongate opening 78 is provided at a position proximate, but spaced from, the base end 60. Positioned substantially opposite the centre point of the elongate opening 78 is a notch 80. The notch 80 extends from the base end 60 to a position roughly equal in height to the lowest point of the elongate opening 78. As such, in this embodiment, the distance between the lowest point of the elongate opening 78 and the base end 60 is equal to the height of the mount base 50.

Flexible tubing 80 is provided within the hollow housing 16, but has a length greater than the hollow housing 16. The flexible tubing 80 has a first threaded end 82 and a second end 84. The first threaded end 82 is threadedly engaged with threaded outlet 34. The second end 84 is coupled to the radiator fan shroud (not shown) of the vehicle 1. The flexible tubing 80 is air tight.

This embodiment of the invention will now be described in the context of its intended installation and operation.

The automotive snorkel 10 is installed to the vehicle 1 such that an upper portion 90 of the automotive snorkel 10 runs alongside the windscreen 2, while a lower portion 92 of the automotive snorkel 10 runs partly along the front fender 7. A hole (not shown) is provided in the front fender 7 to mate with lower open end 20. In this manner, the hole is completed covered by the automotive snorkel 10.

In this arrangement, the opening 22, and by extension the filters 56, are directed towards the windscreen 2.

For the purposes of explanation of this embodiment, the filter mount 40 is already installed in the hollow housing 16 along with its connected flexible tubing 80, but the filters 56 and the face plate 32 have not yet been installed. The second threaded end 84 is manipulated such that the flexible tubing 80 extends through the hole in the front fender 7 to terminate at a position in the engine bay 5.

The filters 56 are then installed. Each filter 56 is manipulated such that it sits over the projection 52 and the notch 80 aligns with keying protrusion 54. Once so aligned, the filter 56 is pressed towards the base 38 so that there is a reasonable interference fit between the mount base 50 and the base end 60.

It is to be noted that this connection now places the elongate opening 78 just above the mount base 50. Similarly, the projection 52 extends only partly into the filter 56.

With all filters 56 installed, the face plate 32 is secured in place. Before securing, the face plate 32 is manipulated such that securing apertures 48 align with apertures 44 and threaded apertures 26. Additionally, each filter aperture 46 is aligned with the face plate end 58 of each filter 56.

When so aligned, the face plate 32 is pushed into place. This causes the face plate 32 to abut the positioning lip 62 of each filter 56 as well as flange 42 and thereby create an air tight seal. The face plate 32 is then secured in place by threaded bolts 90 which extend through securing apertures 48 and apertures 44 to threadedly engage threaded apertures 26.

This completes installation of the automotive snorkel 10. During operation, the automotive snorkel 10 with air filtration system 12 works as follows.

Air reflected by the windscreen 2 enters the automotive snorkel 10 by way of filter apertures 46 in the face plate 32.

As the face plate 32 creates an air tight seal against the positioning lip 62, no air enters the automotive snorkel 10 other than by way of the filters 56. Furthermore, as each filter aperture 46 acts as an inlet for a respective filter 56, this air is channelled towards the curved downwardly sloping wall 70 of a quadrant 64.

Each curved downwardly sloping wall 70 directs the air in a manner that an anti-clockwise vortex is formed in the area between the filter 56 and the projection 52. This anti-clockwise vortex applies a centrifugal force against any contaminants within the air. This ensures that the contaminants are pushed towards inner wall 92 of the filter 56, while the remaining, purified air is drawn through the projection into the hollow housing 16 for ultimate delivery to the existing air intake (not shown) of the vehicle's engine 8 by way of lower outlet 94. This is able to be achieved due to the gap that surrounds all sides of the filter insert 28.

The centrifugal force applied by the anti-clockwise vortex draws the contaminants towards elongate opening 78. When the contaminants reach the elongate opening, they are expelled into the open area of the mounting box 30.

It is to be noted that as the filters 56 expands slightly from the face plate end 58 to the base 60, so too does the inner wall 92. As a result, the Venturi effect operates to reduce the velocity of the particles contained in the anti-clockwise vortex prior to their expulsion through the elongate opening 78. This reduction in velocity also operates to disperse the entrained particulates. This is important, as without such dispersion, the suction force used to draw such particulates all the way to the outlet may not be of sufficient power.

By way of elaboration, the flexible tubing 80 acts as a suction hose for the radiator. Thus, as explained above, the contaminants, by reason of gravity and the suctional force generated by the radiator, are drawn towards the threaded outlet 34. This suction continues to draw the contaminants through the flexible tubing 80 to the radiator where they are expelled to the general environment by the radiator fan.

In accordance with a second embodiment of the invention, where like numerals reference like parts, there is an automotive snorkel 200 for a vehicle 1. The differences between the automotive snorkel 200 of this embodiment and the automotive snorkel 10 of the first embodiment are as follows. Componentry not mentioned below as different is the same in this second embodiment as it is in the first embodiment.

In this embodiment, the hollow housing 16 has a plurality of securing mounts 202 extending about its periphery. Additionally, located proximate the lower open end 20, is a circular hole 204. The positioning of the securing mounts 202 and circular hole 204 align with the mounting points (not shown) for an automotive snorkel as provided by the manufacturer of the vehicle 1. In this manner, the automotive snorkel 200 can be bolted to the vehicle 1.

Additionally, threaded apertures 26 are replaced with smooth apertures 206. The use of a smooth aperture 206 allows for push clips (in place of the threaded bolt) to pass through securing apertures 48, apertures 44 for final retention by way of the smooth apertures 206 in a manner as would be readily known to the person skilled in the art.

Filter 56 is modified for this embodiment, such that there is an inlet portion 208, a middle portion 210 and an outlet portion 212. The inlet portion 208 incorporate the face plate end 58 and the positioning lip 62. The outlet portion 212 incorporates the base end 60. The middle portion 210 extends between the inlet portion 208 and the outlet portion 212.

The inlet portion 208 is of constant cross-sectional diameter. The outlet portion 212 is also of constant cross-sectional diameter. The cross-sectional diameter of inlet portion 208 is smaller than the cross-sectional diameter of outlet portion 212. This means that the middle portion 210 is inwardly tapered as it extends from its connection with the outlet portion 212 to its connection with the inlet portion 208.

The inlet portion 208 is otherwise as described within the first embodiment, however, the curved sloping walls 70 do not extend into the middle portion 210.

The outlet portion 212 is also modified such that a cut-out 214 replaces the elongate opening 78. Additionally, notch 80 is omitted which also results in keying protrusion 54 being omitted.

The second end 84 of this embodiment terminates in a nozzle 216. The nozzle 216 extends from lower open end 20 through the hole in the front fender 7 to extend partly into the engine bay 5. The nozzle 216 is of a type that allows a separate flexible tube to be securely connected thereto.

This embodiment of the invention will now be described in the context of its intended use.

The automotive snorkel 200 is positioned against the vehicle 1 such that the securing mounts 202 and the circular hole 204 axially align with the factory mounting points of the vehicle 1. Threaded bolts (not shown) are then installed through the securing mounts 202/circular hole 204 into the factory mounting points to securely retain the automotive snorkel 200 to the vehicle 1.

With the automotive snorkel 200 now attached to the vehicle 1, the filters 56 are installed. Installation of the filters 56 is achieved by axially aligning projection 52 with the outlet portion 212 such that they are concentric. The filter 56 is then pressed towards the base 38 so that there is a reasonable interference fit between the mount base 50 and the outlet portion 212 (other than at the cut-out 214).

The face plate 32 can now be installed. For this embodiment, this is achieved by installing push clips through securing apertures 48 and 44 for final retention by way of the smooth apertures 206. When properly installed, the face plate 32 again creates an air tight seal against the positioning lip 62 meaning that no air enters the automotive snorkel 200 other than by way of the filters 56.

An air tight hose (not shown) connected to a separate vacuum source (again not shown) is then connected to the nozzle 216.

This completes installation of the automotive snorkel 200. During operation, the automotive snorkel 200 with air filtration system 12 works as follows.

Air reflected by the windscreen 2 enters the automotive snorkel 10 by way of filter apertures 46 in the face plate 32. Each filter aperture 46 acts as an inlet for a respective filter 56, meaning that this air is channelled towards the curved downwardly sloping wall 70 of a quadrant 64.

Each curved downwardly sloping wall 70 directs the air about an angle of 180° in a manner that an anti-clockwise vortex is formed in the area between the filter 56 and the projection 52. This anti-clockwise vortex applies a centrifugal force against any contaminants within the air. This ensures that the contaminants are pushed towards inner wall 92 of the filter 56, while the remaining, purified air is drawn through the projection into the hollow housing 16.

In this embodiment, as the vortex transitions from the inlet portion 208 to the middle portion 210, the filter 56 takes advantage of the Coanda effect so as to stick to the inner wall 92 and initially accelerate any entrained particles. Thereafter, due to the tapered shape of the middle portion 210, the Venturi effect takes over to reduce the velocity of the particles contained in the anti-clockwise vortex prior to their expulsion through the elongate opening 78. This reduction in velocity also operates to disperse the entrained particulates. This is important, as without such dispersion, the force used to draw such particulates all the way to the outlet may not be of sufficient power.

As with the first embodiment, the combination of the centrifugal force applied by the anti-clockwise vortex and the suction generated by the vacuum source draws the contaminants towards cut-out 214. When the contaminants reach the cut-out 214, they are expelled into the open area of the mounting box 30.

Gravity and the suctional force generated by the vacuum source draws these contaminants towards the threaded outlet 34. This suction continues to draw the contaminants through the flexible tubing 80 to the nozzle 216 where they pass therethrough to the air tight hose and, finally, the vacuum source for ultimate disposal or storage.

In accordance with a third embodiment of the invention, where like numerals reference like parts, there is an automotive snorkel 300. The automotive snorkel 300 of this embodiment varies from either of the first two embodiments described in only the following respects.

In this embodiment the threaded outlet 34 is replaced by an outlet 302 while the flexible tubing 80 are omitted. The hollow housing 16 is adapted to create a conduit 304 leading to the outlet 302.

This arrangement sees gravity alone direct contaminants filtered by the filters 56 to pass through the outlet 302 and down the conduit 304 to the environment more generally.

In accordance with a fourth embodiment of the invention, where like numerals reference like parts, there is an automotive snorkel 400. The automotive snorkel 400 adapts the filtering arrangement of any of the previously described automotive snorkels 10, 200, 300. As such, componentry not mentioned below as different is the same in this second embodiment as it is in the first embodiment.

The automotive snorkel 400 includes an active filtration system 402. The active filtration system 402 incorporates an RPM sensor 404. The RPM sensor 404 detect the current revolutions per minute (RPM) of the vehicle's engine 8.

The active filtration system 402 is also in control communication with butterfly valves 406. Each butterfly valve 406 forms part of the filter 56.

This embodiment of the invention will now be described in the context of its intended use.

The active filtration system 402 sets each butterfly valve 406 to an open position. In doing so, each of the filters 56 forming part of the air filtration system 12 is operational (i.e allowing air to pass therethrough for filtration). At the same time, the active filtration system 402 starts receiving data periodically from the RPM sensor 404.

Whenever the active filtration system 402 receives data from the RPM sensor 404 it compares the data against a reference dataset 408. The reference data set 408 contains details of the optimal number of filters 56 that should remain operational for the current RPM value of the engine. Hence, the comparison results in the active filtration system 402 arriving at the number of filters 56 that should presently be operational for the current RPM value of the engine (hereafter the “optimal number”).

If the number of filters 56 that are operational is less than the optimal number, the active filtration system 402 sends a command signal to a butterfly valve 406 presently in a closed position to move to an open position. This repeats until such time as the number of butterfly valves 406 then set to an open position equals the optimal number.

Conversely, if the number of filters 56 that are operational is greater than the optimal number, the active filtration system 402 sends a command signal to a butterfly valve 406 presently in an open position to move to a closed position. This repeats until such time as the number of butterfly valves 406 then set to an open position equals the optimal number.

It is to be appreciated that the invention as described can be incorporated as either an after-market part that is retrofitted to the vehicle 1 or incorporated as part of the general design of the vehicle 1 at its point of manufacture. Similarly, while the invention has been described in the context of filtration of particulates, the applicant is of the view that the invention facilitates the filtration of anything heavier than air—such as water droplets.

It should be further appreciated by the person skilled in the art that the above invention is not limited to the embodiments described. In particular, the following modifications and improvements may be made without departing from the scope of the present invention:
The invention has been described with the face plate 32 being at right angles to the direction of travel of the vehicle 1. This is to prevent bugs from blocking the filters 56. However, there is no requirement for the face plate 32 to be positioned in such an arrangement and a face plate 32 placed in any orientation relative to the direction of travel of the vehicle 1 is considered within the scope of this invention. For the sake of clarity, this includes automotive snorkels 10, 200, 300, 400 having face plates 32 that face either away or towards the direction of travel of the vehicle 1.
The length and angle of the curved sloping walls 70 may be adjusted as needed to meet the particular environmental conditions in which the vehicle 1 operates. However, the applicant considers it particularly important that the curved downwardly sloping wall 70 terminate at a position underneath the curved downwardly sloping wall 70 of an adjacent quadrant 64. In this manner, contaminants must enter the main body of each filter 56 by way of the sloping wall 70, which creates the required vortex effect, rather than entering the main body directly and in a substantially linear fashion.
Preferably the curved downwardly sloping wall extends around an angle of at least 180°.
Similarly, the size of the filters 56 may be similarly adjusted to meet the particular environmental conditions in which the vehicle 1 operates.
The number of quadrants 64 employed by each filter 56 may differ from those described. For instance, in one variation the number of quadrants 64 employed may be greater than the four (4) described in the embodiments. Similarly, in a second variation the number of quadrants 64 employed may be less than the four (4) described in the embodiments. In a yet further variation, the quadrants 64 may be omitted in favour of a single opening that directs the incoming air about a corkscrew wall so as to form the required vortex.
In a further variation, the size of the quadrants 64 may vary in size relative to each other. For instance, in one variation, the four quadrants 64 may be split into a pair of smaller quadrants and a pair of larger quadrants configured in an alternating arrangement (i.e. each larger quadrant is adjacent the two smaller quadrants).
Differing layouts to the filters 56 within the mounting box 30 may be used. For instance, the filters 56 may be arranged in more than two columns and/or need not be offset from one another.
The automotive snorkel 10, 200, 300, 400 may incorporate a pre-cleaner.
The first embodiment described shows the position of the keying protrusion 54 and elongate opening 78 in their preferred locations. However, there is no reason why either the keying protrusion 54 or the elongate opening 78 may not be provided at other locations.
The purified air may be directed towards a pre-engine filtration system that leads to the existing air intake, rather than directly to the existing air intake. Similarly, the purified air might be directed to a truck air box or be integrated with a truck air box.
The filter mounts 40 may be modified such that they may be manually closed when more filter mounts 40 are provided than either filters 56 available or filters 56 needed. Once method of manually closing off such filter mounts 40 is the installation of an air tight cover over the projection 52.
Air passing through the filters 56 may be directed to create a clockwise or counter-clockwise vortex.
The automotive snorkel 10, 200, 300, 400 may be made using a rotational moulding technique to create a single hollow structure, rather than the two-part structure described in the embodiments. Alternatively, the automotive snorkel 10, 200 may be created using other moulding processes such as machining or three-dimensional printing.
The opening 22 may take other shapes. For instance, the opening may be circular, or elliptical, in shape.
The active filtration system 402 may operate based on sensors other than, or in conjunction with, the RPM sensor 404. For instance, the active filtration system 402 may operate based on the measurements of an air pressure sensor or sensor coil.
Alternatively, the active filtration system 402 need not be a separate processing unit. Rather the state of the butterfly valves 406 may be determined manually by the current level of air pressure in the hollow housing 16.
Other systems may be used to shut off filters than butterfly valves 406. For instance, a guillotine valve may be used in its place.
The automotive snorkel 10, 200, 300, 400 may be adapted to store the contaminants filtered by the filters 56 rather than expel them into the environment as described.
In a variation of the second embodiment, or the version described in the preceding paragraph, the conduit leading to the external environment or store may have a fan installed therein. This fan operates to apply an additional suctional force to the filters 56 by way of elongate opening 78 or cut-out 214. This additional suctional force assists in ensuring that the filters 56 are always operating efficiently. This fan may be of variable speed to account for environmental and operational conditions.
In a variation of the second embodiment, the separate vacuum source can be any normal element of the vehicle 1 that naturally produces a vacuum during operation or can be a specific after-market element that is installed as an adjunct to the automotive snorkel 200.
Each embodiment of the invention described above references filters 56 in which the external profile matches the internal profile. However, this need not be the case and in such situations, it is the internal profile which must be tapered as described in the embodiments.
While it is preferable that the curved downwardly sloping wall 70 extends about an angle of 180°, the curved downwardly sloping wall 70 may extend about a central axis extending through the circular hub 68 to differing extents.
It is to be appreciated that the embodiments of the invention described may be used in combination with any engine type, including conventional combustion engines and hydrogen fuel cell engines.
In addition to using the RPM sensor 404, and other sensors, to determine the optimal number of filters 56 that should be operational, the same data may be used to determine which filters 56 should be operational. In doing so, a control system may take into account such as current efficiencies of varying filters 56 to determine which filters 56 should remain operational and which should close (or vice versa).

It should be further appreciated by the person skilled in the art that the invention is not limited to the embodiments described above. Additions or modifications described, where not mutually exclusive, can be combined to form yet further embodiments that are considered to be within the scope of the present invention.

1. An automotive snorkel for a vehicle having an engine bay in which an engine incorporating an air intake system is located, the automotive snorkel comprising:
a hollow housing having an upper opening and at least one lower outlet proximate the engine bay;
a mounting box configured to be received in the upper opening, the mounting box including a plurality of filter mounts and a filtration outlet to an external environment; and
a plurality of removable filters each having a corresponding air inlet, each removable filter configured to be securely retained by a filter mount,
wherein, in use and when installed on the vehicle, air only enters the automotive snorkel by way of the upper opening where the air is directed towards the air inlets to filter particles entrained in the air using centrifugal force,
wherein the filtered particles are thereafter expelled to the mounting box before being directed to the external environment by way of the filtration outlet, and
wherein the filtered air is directed through the filter mounts and the hollow housing to the at least one lower outlet for subsequent delivery to the engine.

2. (canceled)

3. (canceled)

4. The automotive snorkel for a vehicle according to claim 1, further comprising:
an air-tight tubing contained within the hollow housing, the tubing terminating at a connected end at the filtration outlet and either terminating at an unconnected end at a lower outlet proximate the engine bay, separate to a lower outlet used to deliver purified air to the air intake system when installed on the vehicle and in use, or the unconnected end extends through the at least one lower outlet into the engine bay.

5. The automotive snorkel for a vehicle according to claim 4, wherein the tubing is flexible and the unconnected end terminates in a nozzle.

6. The automotive snorkel for a vehicle according to claim 4, wherein the unconnected end is attached to a vacuum source.

7. The automotive snorkel for a vehicle according to claim 6, wherein the vacuum source is a radiator fan of the vehicle.

8. (canceled)

9. (canceled)

10. The automotive snorkel for a vehicle according to claim 1, wherein:
each filter mount comprises a hollow mount base and a hollow projection, and
the removable filter is configured to form an interference fit with the hollow mount base.

11. The automotive snorkel for a vehicle according to claim 10, wherein:
the filter mount includes a keying projection,
the removable filter includes a notch, and
the notch is configured to receive the keying projection when the removable filter is installed about the hollow mount base.

12. The automotive snorkel for a vehicle according to claim 11, wherein the keying projection of each filter mount extends from the hollow mount base at the same position and at the same angle.

13. The automotive snorkel for a vehicle according to claim 10, wherein the air inlet is divided into at least two segments, each segment incorporating a curved downwardly sloping wall that directs air that passes through the filter to form a vortex in a space between the hollow projection and an internal wall of the removable filter.

14. The automotive snorkel for a vehicle according to claim 13, wherein each downwardly sloping wall has an exterior end and an internal end, and the internal end terminates at a position below the exterior end of an adjacent downwardly sloping wall.

15. The automotive snorkel for a vehicle according to claim 13, wherein the internal wall is tapered.

16. The automotive snorkel for a vehicle according to claim 13, wherein:
the removable filter includes a middle segment,
the air inlet has a lateral cross-section of a first constant diameter and an outlet end having a lateral cross-section of a second constant diameter, and
the middle segment tapers from the outlet end to the air inlet.

17. The automotive snorkel for a vehicle according to claim 13, wherein:
each removable filter has an outlet end, and
the outlet end incorporates a cut-out, the filtered particles being expelled into the mounting box by way of the cut-out.

18. (canceled)

19. The automotive snorkel for a vehicle according to claim 1, wherein each removable filter has at least an open state and a closed state and an active filtration system is operable to control a current state of each removable filter.

20. The automotive snorkel for a vehicle according to claim 19, further comprising:
at least one sensor,
wherein the active filtration system is operable to control the current state of each removable filter based on measurements provided by the at least one sensor.

21. The automotive snorkel for a vehicle according to claim 20, wherein the at least one sensor is at least one of (i) a sensor configured to detect a current RPM of the engine, and (ii) a sensor configured to detect a current air pressure within the automotive snorkel.

22. The automotive snorkel for a vehicle according to claim 20, further comprising:
a reference dataset,
wherein the active filtration system is operable to check the reference dataset against the measurements provided by the at least one sensor to determine an optimal number of open valves, and
wherein the active filtration system is operable to control the current state of each removable filter until the number of filters set to an open state is equal to the optimal number.

23. The automotive snorkel for a vehicle according to claim 19, wherein the active filtration system is operable to control the current state of each removable filter based on a position of its associated filter mount in the mounting box.

24. The automotive snorkel according to claim 19, wherein each removable filter includes a butterfly valve or a guillotine valve to facilitate a change of state.

25. (canceled)

26. (canceled)

27. (canceled)

28. (canceled)

29. The automotive snorkel for a vehicle according to claim 1, wherein the upper opening faces towards a windscreen of the vehicle.

30. (canceled)
